(19) United States
(12) Patent Application Publication
(10) Pub. No.: US 2014/0164718 A1
(43) Pub. Date: Jun. 12, 2014

(54) METHODS AND APPARATUS FOR SHARING MEMORY BETWEEN MULTIPLE PROCESSES OF A VIRTUAL MACHINE

(71) Applicant: OPEN KERNEL LABS, INC., Chicago, IL (US)

(72) Inventors: Carl Frans van Schaik, Kingsford (AU); Philip Geoffrey Derrin, Carlingford (AU)

(73) Assignee: Open Kernel Labs, Inc., Chicago, IL (US)

(21) Appl. No.: 13/707,785

(22) Filed: Dec. 7, 2012

(51) Int. Cl. G06F 12/10

(52) U.S. Cl. CPC G06F 12/1072
USPC 711/150

(57) ABSTRACT

Methods and apparatus for sharing memory between multiple processes of a virtual machine are disclosed. A hypervisor associates a plurality of guest user memory regions with a first domain and assigns each associated user process an address space identifier to protect the different user memory regions from the different user processes. In addition, the hypervisor associates a global kernel memory region with a second domain. The global kernel region is reserved for the operating system of the virtual machine and is not accessible to the user processes, because the user processes do not have access rights to memory regions associated with the second domain. The hypervisor also associates a global shared memory region with a third domain. The hypervisor allows user processes associated with the third domain to access the global shared region. Using this global shared memory region, different user processes within a virtual machine may share data without the need to swap the shared data in and out of each processes respective user region of memory.

The present disclosure relates in general to virtual machines, and, in particular, to methods and apparatus for sharing memory between multiple processes of a virtual machine.

### BACKGROUND

A hypervisor is a software interface between the physical hardware of a computing device, such as a wireless telephone or vehicle user interface system, and multiple operating systems. Each operating system managed by the hypervisor is associated with a different virtual machine, and each operating system appears to have exclusive access to the underlying hardware, such as processors, user interface devices, and memory. However, the hardware is a shared resource, and the hypervisor controls all hardware access (e.g., via prioritized time sharing).

In order to give each virtual machine the appearance of exclusive access to physical memory, the hypervisor partitions the physical memory in to a plurality of protected memory regions. Each memory region is typically allocated to a guest operating system, which in turn partitions its available memory between one or more user regions and one or more kernel regions. For example, a guest operating system may dynamically allocate one memory partition (user region) to each of a plurality of user processes (e.g., touch screen control, MP3 player, etc.) and one additional memory partition for the guest operating system (kernel regions).

When the a guest OS switches from one process to another process, the hypervisor changes which mappings associated with the user regions are active. However, in this example, mappings associated with the kernel region remain the same. When the hypervisor switches from one virtual machine to a different virtual machine (world switch) with a different set of processes, activation of mappings associated with the user region change, and activation of mappings associated with the kernel region change.

Memory associated with one virtual machine process is typically not accessible to other virtual machine processes, even within the same virtual machine. In order for two or more processes within a virtual machine to share data, complex copying and/or memory mapping occurs.

### BRIEF DESCRIPTION OF THE DRAWINGS

FIG. 1 is a block diagram of an example network communication system.

FIG. 2 is a block diagram of an example electronic device.

FIG. 3 is a block diagram of another example electronic device.

FIG. 4 is a block diagram of yet another example electronic device.

FIG. 5 is a flowchart of an example process for sharing memory between multiple processes of a virtual machine.

FIGS. 6-7 are a flowchart of another example process for sharing memory between multiple processes of a virtual machine.

FIG. 8 is an example memory map for sharing memory between multiple processes of a virtual machine.

### DETAILED DESCRIPTION OF THE PREFERRED EMBODIMENTS

Briefly, methods and apparatus for sharing memory between multiple processes of a virtual machine are disclosed. In an embodiment, a hypervisor associates a plurality of guest user memory regions with a first domain and assigns each associated user process an address space identifier to protect the different user memory regions from the different user processes. In addition, the hypervisor associates a global kernel memory region with a second domain. The global kernel region is reserved for the operating system of the virtual machine and is not accessible to the user processes, because the user processes do not have access rights to memory regions associated with the second domain. The hypervisor also associates a global shared memory region with a third domain. The hypervisor allows user processes (additionally) associated with the third domain to access the global shared region. Among other advantages, using this global shared memory region, different user processes within a virtual machine may share data without the need to swap the shared data in and out of each processes respective user region of memory.

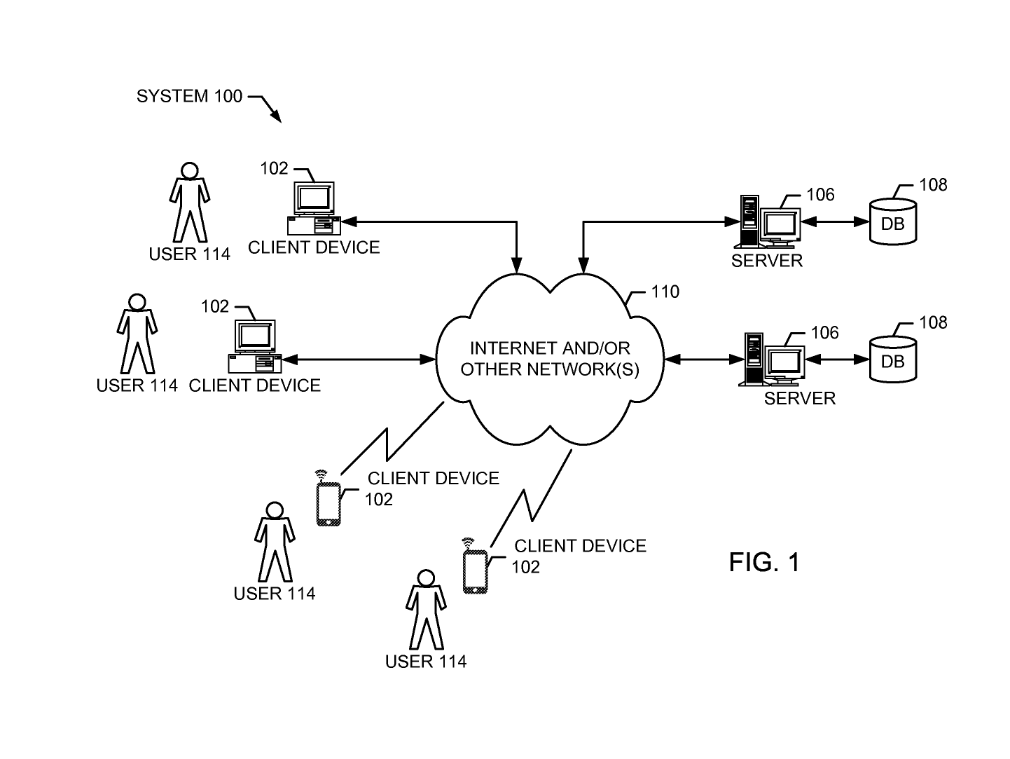

The present system may be used in a network communications system. A block diagram of certain elements of an example network communications system 100 is illustrated in FIG. 1. The illustrated system 100 includes one or more client devices 102 (e.g., computer, television, camera, phone), one or more web servers 106, and one or more databases 108. Each of these devices may communicate with each other via a connection to one or more communications channels 110 such as the Internet or some other wired and/or wireless data network, including, but not limited to, any suitable wide area network or local area network. It will be appreciated that any of the devices described herein may be directly connected to each other instead of over a network.

The web server 106 stores a plurality of files, programs, and/or web pages in one or more databases 108 for use by the client devices 102 as described in detail below. The database 108 may be connected directly to the web server 106 and/or via one or more network connections. The database 108 stores data as described in detail below.

One web server 106 may interact with a large number of client devices 102. Accordingly, each server 106 is typically a high end computer with a large storage capacity, one or more fast microprocessors, and one or more high speed network connections. Conversely, relative to a typical server 106, each client device 102 typically includes less storage capacity, fewer low power microprocessors, and a single network connection.

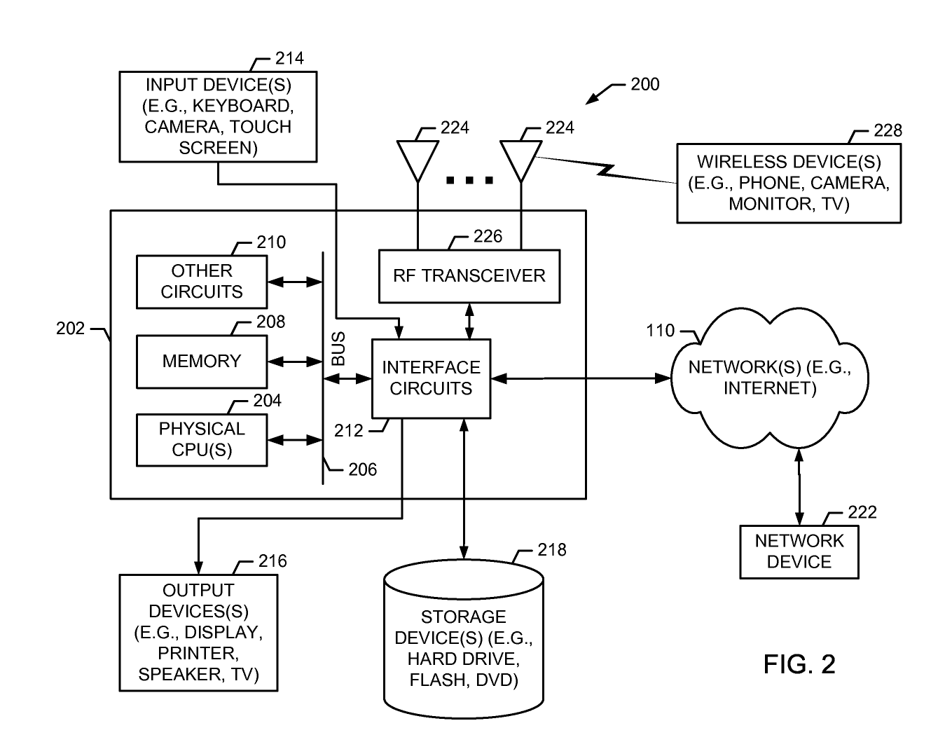

Each of the devices illustrated in FIG. 1 may include certain common aspects of many electronic devices such as microprocessors, memories, peripherals, etc. A block diagram of certain elements of an example electronic device 200 that may be used to capture, store, and/or playback digital video is illustrated in FIG. 2. For example, the electrical device 200 may be a client, a server, a camera, a phone, and/or a television.

The example electrical device 200 includes a main unit 202 which may include, if desired, one or more physical processors 204 electrically coupled by an address/data bus 206 to one or more memories 208, other computer circuitry 210, and one or more interface circuits 212. The processor 204 may be any suitable processor or plurality of processors. For example, the electrical device 200 may include a central processing unit (CPU) and/or a graphics processing unit (GPU). The memory 208 may include various types of non-transitory memory including volatile memory and/or non-volatile memory such as, but not limited to, distributed memory, read-only memory (ROM), random access memory (RAM) etc. The memory 208 typically stores a software program that interacts with the other devices in the system as described herein. This program may be executed by the processor 204 in any suitable manner. The memory 208 may also store digital data indicative of documents, files, programs, web pages, etc. retrieved from a server and/or loaded via an input device 214.

The interface circuit 212 may be implemented using any suitable interface standard, such as an Ethernet interface and/or a Universal Serial Bus (USB) interface. One or more input devices 214 may be connected to the interface circuit 212 for entering data and commands into the main unit 202. For example, the input device 214 may be a keyboard, mouse, touch screen, track pad, isopoint, camera and/or a voice recognition system.

One or more displays, printers, speakers, monitors, televisions, high definition televisions, and/or other suitable output devices 216 may also be connected to the main unit 202 via the interface circuit 212. The display 216 may be a cathode ray tube (CRTs), liquid crystal displays (LCDs), or any other type of suitable display. The display 216 generates visual displays of data generated during operation of the device 200. For example, the display 216 may be used to display web pages and/or other content received from a server. The visual displays may include prompts for human input, run time statistics, calculated values, data, etc.

One or more storage devices 218 may also be connected to the main unit 202 via the interface circuit 212. For example, a hard drive, CD drive, DVD drive, and/or other storage devices may be connected to the main unit 202. The storage devices 218 may store any type of data used by the device 200.

The electrical device 200 may also exchange data with other network devices 222 via a connection to a network. The network connection may be any type of network connection, such as an Ethernet connection, digital subscriber line (DSL), telephone line, coaxial cable, etc. Users of the system may be required to register with a server. In such an instance, each user may choose a user identifier (e.g., e-mail address) and a password which may be required for the activation of services. The user identifier and password may be passed across the network using encryption built into the user's browser. Alternatively, the user identifier and/or password may be assigned by the server.

In some embodiments, the device 200 may be a wireless device. In such an instance, the device 200 may include one or more antennas 224 connected to one or more radio frequency (RF) transceivers 226. The transceiver 226 may include one or more receivers and one or more transmitters. For example, the transceiver 226 may be a cellular transceiver. The transceiver 226 allows the device 200 to exchange signals, such as voice, video and data, with other wireless devices 228, such as a phone, camera, monitor, television, and/or high definition television. For example, the device may send and receive wireless telephone signals, text messages, audio signals and/or video signals.

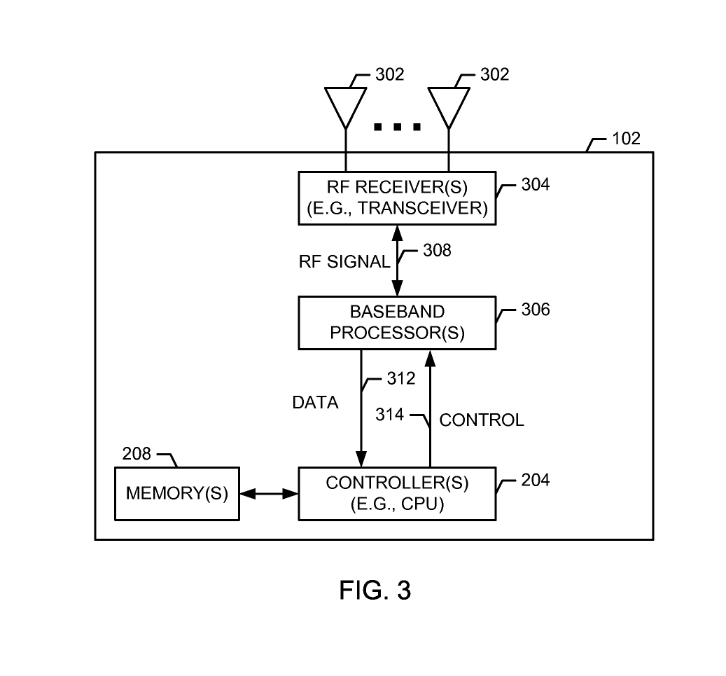

A block diagram of certain elements of an example wireless device 102 for sharing memory between multiple processes of a virtual machine is illustrated in FIG. 3. The wireless device 102 may be implemented in hardware or a combination of hardware and hardware executing software. In one embodiment, the wireless device 102 may include a CPU executing software. Other suitable hardware may include one or more application specific integrated circuits (ASICs), state machines, field programmable gate arrays (FPGAs), and/or digital signal processors (DSPs).

In this example, the wireless device 102 includes a plurality of antennas 302 operatively coupled to one or more radio frequency (RF) receivers 304. The receiver 304 is also operatively coupled to one or more baseband processors 306. The receiver 304 tunes to one or more radio frequencies to receive one or more radio signals 308, which are passed to the baseband processor 306 in a well known manner. The baseband processor 306 is operatively coupled to one or more controllers 310. The baseband processor 306 passes data 312 to the controller 310. A memory 316 operatively coupled to the controller 310 may store the data 312.

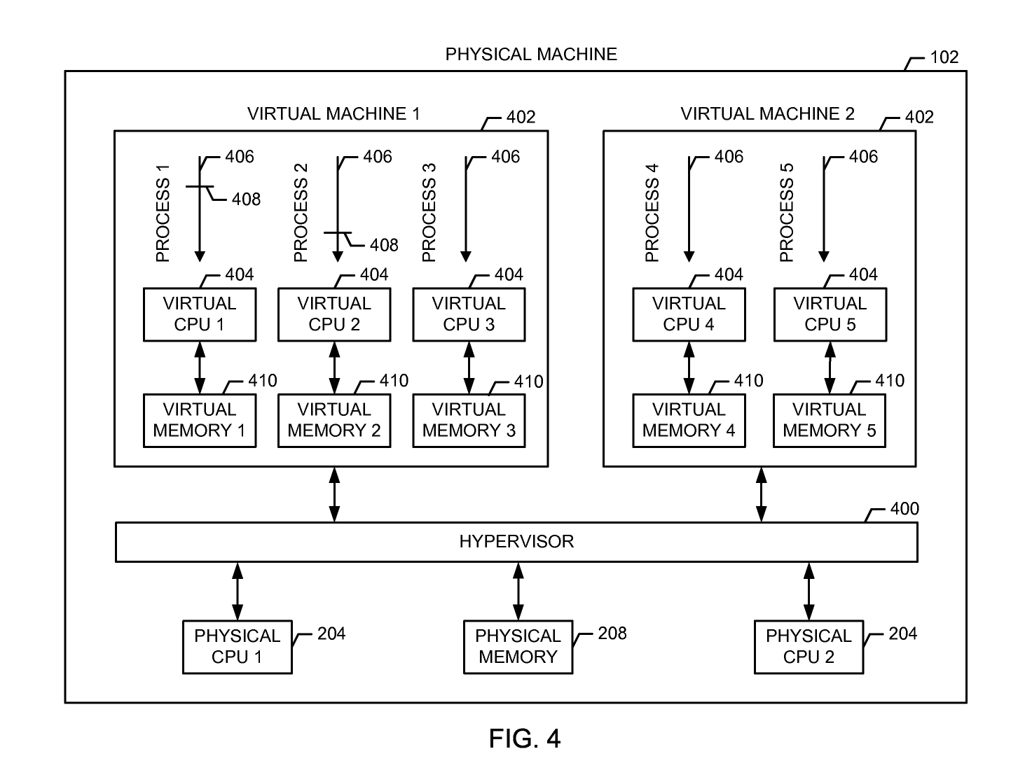

A block diagram of certain elements of yet another example electronic device is illustrated in FIG. 4. In this example, a physical machine 102 includes two physical processors 204. However, any suitable number of physical processors 204 may be included in the physical machine 102. For example, the physical machine 102 may include a multi-core central processing unit with four or more cores. The physical machine 102 also includes one or more physical memories 208 for use by the physical processors 204. For example, the physical machine 102 may include dynamic random access memory (DRAM).

A plurality of virtual machines 402 execute within the physical machine 102. Each virtual machine 402 is a software implementation of a computer and the operating system associated with that computer. Different virtual machines 402 within the same physical machine 102 may use different operating systems. For example, a mobile communication device may include three virtual machines 402 where two of the virtual machines 402 are executing the Android operating system and one of the virtual machines 402 is executing a different Linux operating system.

Each virtual machine 402 includes one or more virtual processors 404 and associated virtual memory 410. Each virtual processor 404 executes one or more processes 406 using one or more of the physical processors 204. Similarly, the contents of each virtual memory 410 are stored in the physical memory 208.

A hypervisor 400 controls access by the virtual machines 402 to the physical processors 204 and the physical memory 208. More specifically, the hypervisor 400 schedules each virtual processor 404 to execute one or more processes 406 on one or more physical processors 204 according to the relative priorities associated with the virtual machines 402. Once the hypervisor 400 schedules a process 406 to execute on a physical processor 204, the process 406 typically advances to a progress point 408 unless suspended by the hypervisor 400.

The hypervisor 400 also allocates physical memory 208 to each of the virtual processors 404. In some instances, the hypervisor 400 protects one portion of physical memory 208 associated with one process 406 from another portion of physical memory 208 associated with another process 406. In other instances, the hypervisor 400 allows one portion of physical memory 208 associated with one process 406 to be accessed by another virtual processor 404 associated with another process 406. In this manner, the hypervisor 400 facilitates the sharing of memory between multiple processes 406 of a virtual machine 402.

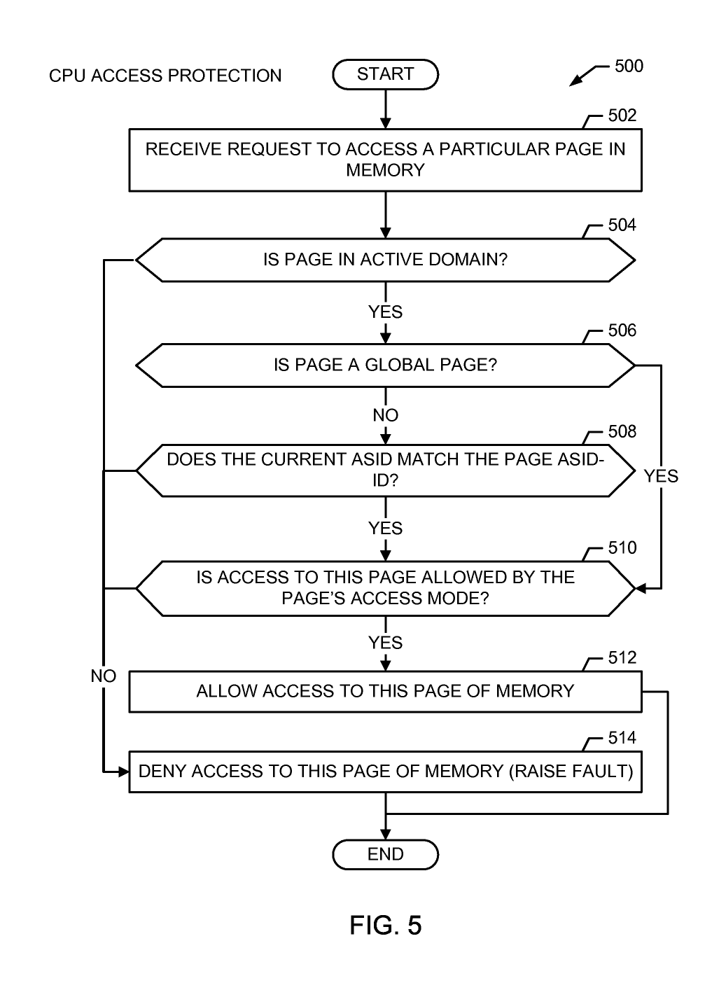

A flowchart of an example process 500 for accessing memory in a system supporting the sharing of memory between multiple processes of a virtual machine is illustrated in FIG. 5. The process 500 may be carried out by one or more suitably programmed processors such as a CPU executing software (e.g., block 204 of FIG. 2). The process 500 may also be embodied in hardware or a combination of hardware and hardware executing software. Suitable hardware may include one or more application specific integrated circuits (ASICs), state machines, field programmable gate arrays (FPGAs), digital signal processors (DSPs), and/or other suitable hardware. Although the process 500 is described with reference to the flowchart illustrated in FIG. 5, it will be appreciated that many other methods of performing the acts associated with process 500 may be used. For example, the order of many of the operations may be changed, and some of the operations described may be optional.

In general, a hypervisor 400 receives a request to access a particular page in physical memory 208. The hypervisor 400 determines if the requester is allowed to access requested memory based on the domain, address space identifier, and access mode associated with the current memory access request.

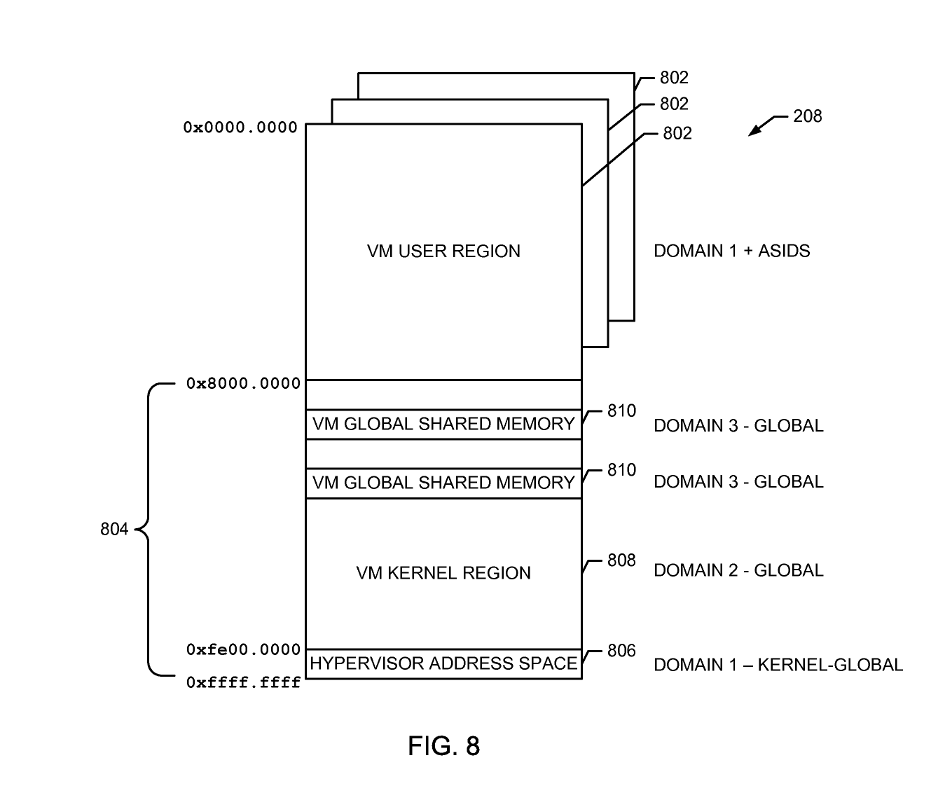

More specifically, the example process 500 begins when the processor 204 receives a request to access a particular page in physical memory 208 (block 502). For example, the processor 204 may receive a request to access a user region 802, a kernel region 808, or a shared region 810 in physical memory 208 (see example memory map 800 of FIG. 8). The hypervisor 400 then determines if the requested memory page is in an active domain (block 504). For example, the hypervisor 400 may determine if the requested memory page is in a first domain, a second domain, or a third domain. If the requested memory page is in an active domain, the hypervisor 400 determines if the requested memory page is a global memory page (block 506). For example, the hypervisor 400 may determine if the requested memory page is in a global kernel region or a global shared region.

If the requested memory page is not a global memory page, the hypervisor 400 determines if the address space identifier (ASID) associated with the requesting user process matches the address space identifier associated with the requested memory page (block 508). For example, the hypervisor 400 may determine if a touch screen user interface process 406 is requesting access to memory associated with the touch screen user interface process 406 or an audio player process 406. If the address space identifier associated with the requesting user process matches the address space identifier associated with the requested memory page, or the requested memory page is a global memory page, the hypervisor 400 determines if access to the requested memory page is currently allowed based on the access mode currently associated with the requested memory page (block 510). For example, the hypervisor 400 may determine if the access mode associated with the requested memory page is privileged.

If access to the requested memory page is currently allowed based on the access mode currently associated with the requested memory page, the hypervisor 400 allows access to the requested memory page by the requesting process (block 512). If (i) the requested memory page is not in an active domain (block 504), (ii) the address space identifier associated with the requesting user does not match the address space identifier associated with the requested memory page (block 508), or (iii) access to the requested memory page is not currently allowed based on the access mode currently associated with the requested memory page (block 510), the hypervisor 400 does not allow access to the requested memory page by the requesting process (block 514).

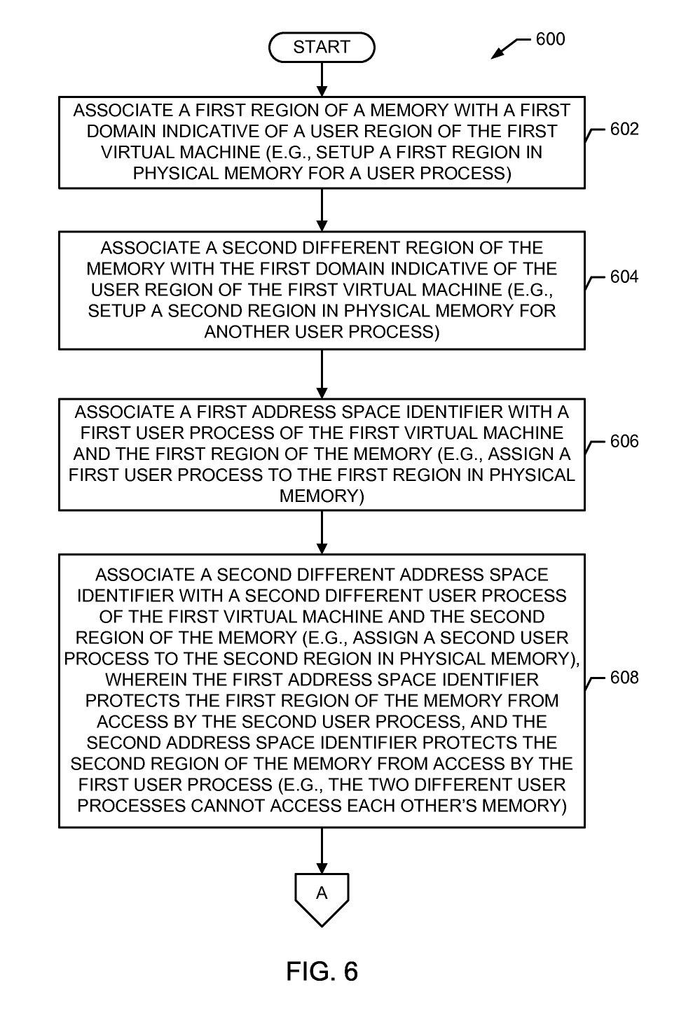

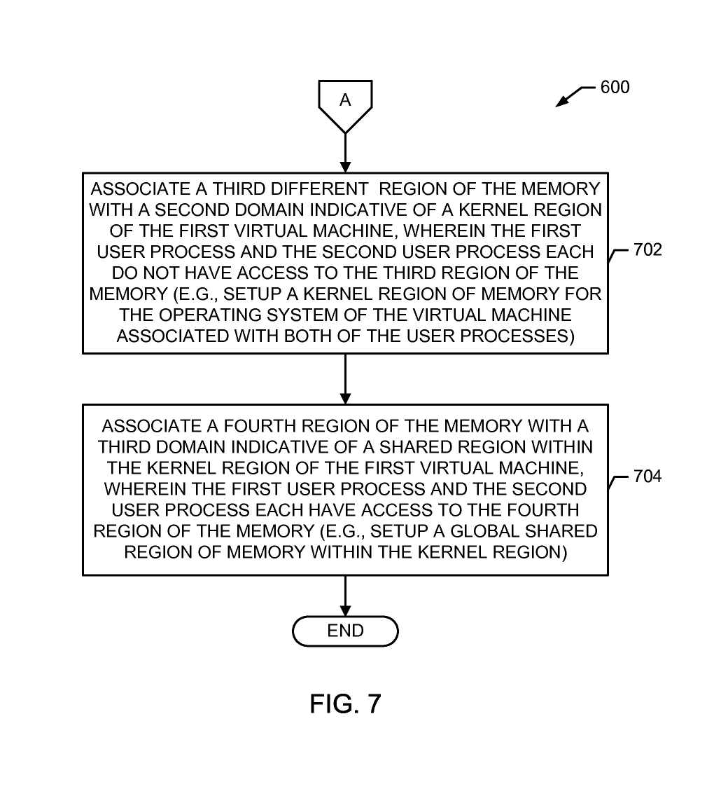

A flowchart of another example process 600 for sharing memory between multiple processes of a virtual machine is illustrated in FIGS. 6-7. The process 600 may be carried out by one or more suitably programmed processors such as a CPU executing software (e.g., block 204 of FIG. 2). The process 600 may also be embodied in hardware or a combination of hardware and hardware executing software. Suitable hardware may include one or more application specific integrated circuits (ASICs), state machines, field programmable gate arrays (FPGAs), digital signal processors (DSPs), and/or other suitable hardware. Although the process 600 is described with reference to the flowchart illustrated in FIGS. 6-7, it will be appreciated that many other methods of performing the acts associated with process 600 may be used. For example, the order of many of the operations may be changed, and some of the operations described may be optional.

In general, a hypervisor associates a plurality of guest user memory regions with a first domain and assigns each associated user process an address space identifier to protect the different user memory regions from the different user processes. In addition, the hypervisor associates a global kernel memory region with a second domain. The global kernel region is reserved for the operating system of the virtual machine and is not accessible to the user processes, because the user processes do not have access rights to memory regions associated with the second domain. The hypervisor also associates a global shared memory region with a third domain. The hypervisor allows user processes associated with the third domain to access the global shared region. Using this global shared memory region, different user processes within a virtual machine may share data without the need to swap the shared data in and out of each processes respective user region of memory.

More specifically, the example process 600 begins when the hypervisor 400 associates a first region 802 of a memory 208 with a first domain indicative of a user region 802 (see example memory map 800 of FIG. 8) of the first virtual machine 402 (block 602). For example, the hypervisor 400 may setup a first region 802 in physical memory 208 for a user process 406. The hypervisor 400 also associates a second different region 802 of the memory 208 with the first domain indicative of the user region 802 of the first virtual machine 402 (block 604). For example, the hypervisor 400 may setup a second region 802 in physical memory 208 for another user process 406.

The hypervisor 400 also associates a first address space identifier (ASID) with a first user process 406 of the first virtual machine 402 and the first region 802 of the memory 208 (block 606). For example, the hypervisor 400 may assign a touch screen user interface process 406 to the first region in physical memory 208. The hypervisor 400 also associates a second different address space identifier (ASID) with a second different user process 406 of the first virtual machine 402 and the second region 802 of the memory 208, wherein the first address space identifier protects the first region 802 of the memory 208 from access by the second user process 406, and the second address space identifier protects the second region 802 of the memory 208 from access by the first user process 406 (block 608). For example, the hypervisor 400 may assign an audio player process 406 to the second region 802 in physical memory 208, wherein the address space identifier associated with the touch screen user interface process 406 protects the touch screen user interface process memory 802 from the audio player process 406, and the address space identifier associated with the audio player process 406 protects the audio player process memory 802 from the touch screen user interface process 406.

The hypervisor 400 also associates a third different region 804 of the memory 208 with a second domain indicative of a kernel region 804 of the first virtual machine 402, wherein the first user process 406 and the second user process 406 each do not have access to the third region 804 of the memory (block 702). For example, the hypervisor 400 may setup a kernel region 804 of memory 208 for the operating system of the virtual machine 402 associated with both the touch screen user interface process 406 and the audio player process 406.

The hypervisor 400 also associates a fourth region 810 of the memory 208 with a third domain indicative of a shared region 810 within the kernel region 804 of the first virtual machine 402, wherein the first user process 406 and the second user process 406 each have access to the fourth region 810 of the memory 208 (block 704). For example, the hypervisor 400 may setup a global shared region 810 of memory 208 within the kernel region 804.

In an embodiment, the first domain, the second domain, and the third domain are each one of a finite number of physical processor domains. For example, a processor architecture may support sixteen memory domains. In an embodiment, the physical processor's domains are recycled. For example, an infrequently used domain may be swapped out for a new and/or frequently used domain. In an embodiment, the hypervisor 400 switches from the first user process to the second user process by storing the second address space identifier in at least one register. In an embodiment, address space identifiers are recycled. For example, an infrequently used address space identifier may be swapped out for a new and/or frequently used process.

An example memory map 800 for sharing physical memory 208 between multiple processes of a single virtual machine 402 is illustrated in FIG. 8. Other virtual machines 402 within the same physical machine 102 may have similar memory maps. In this example, a plurality of different virtual machine memory regions 802 is associated with a first domain identifier. The first domain identifier indicates that each of these memory regions 802 is a user region 802. In addition, each user region 802 is associated with a unique address space identifier (ASID). The address space identifiers protect physical memory 208 associated with one user process 406 from other user processes 406.

The physical memory 208 also includes a kernel region 804. In this example, the kernel region 804 includes a hypervisor region 806 and a global kernel region 808. In this example, the hypervisor region 806 is associated with the first domain. However, the hypervisor region 806 is reserved for exclusive use by the hypervisor 400 and is not accessible by the user processes 406 because the hypervisor region 806 is also associated with a privileged (non-user) access mode. In this example, the global kernel region 808 is associated with a second domain. The global kernel region 808 is reserved for the operating system of the virtual machine 402 and is not accessible to the user processes 406, because the user processes 406 do not have access rights to memory regions associated with the second domain.

In addition, the kernel region 804 includes a global shared region 810. In this example, the global shared region 810 is associated with a third domain. The global shared region 810 may be accessible to some user processes 406 and inaccessible to other user processes 406. More specifically, the hypervisor 400 allows user processes 406 associated with the third domain to access the global shared region 810, and the hypervisor 400 does not allow user processes 406 that are not associated with the third domain to access the global shared region 810. Using this global shared memory region 810, different user processes 406 may share data without the need to swap the shared data in and out of each processes 406 respective user region 802.

The foregoing description has been presented for the purposes of illustration and description. It is not intended to be exhaustive or to limit the invention to the exemplary embodiments disclosed. Many modifications and variations are possible in light of the above teachings. It is intended that the scope of the invention be limited not by this detailed description of examples, but rather by the claims appended hereto.

What is claimed is:

1. A method of sharing memory between multiple processes of a first virtual machine, the method comprising:
associating a first region of a memory with a first domain indicative of a user region of the first virtual machine;
associating a second different region of the memory with the first domain indicative of the user region of the first virtual machine;
associating a first address space identifier with a first user process of the first virtual machine and the first region of the memory;
associating a second different address space identifier with a second different user process of the first virtual machine and the second region of the memory, wherein the first address space identifier protects the first region of the memory from access by the second user process, and the second address space identifier protects the second region of the memory from access by the first user process;
associating a third different region of the memory with a second domain indicative of a kernel region of the first virtual machine, wherein the first user process and the second user process each do not have access to the third region of the memory; and
associating a fourth region of the memory with a third domain indicative of a shared region within the kernel region of the first virtual machine, wherein the first user process and the second user process each have access to the fourth region of the memory.

2. The method of claim 1, wherein the first domain, the second domain, and the third domain are each one of a finite number of physical processor domains.

3. The method of claim 2, wherein the finite number of physical processor domains is recycled.

4. The method of claim 1, including switching from the first user process to the second user process by storing the second address space identifier in at least one register.

5. The method of claim 1, wherein a finite number of address space identifiers are recycled.

6. The method of claim 1, including:
storing the first address space identifier in at least one register;
scheduling the first user process for execution on at least one physical processor; and
allowing the first user process to access data in the fourth region of the memory.

7. The method of claim 6, including:
storing the second address space identifier in the at least one register;
scheduling the second user process for execution on the at least one physical processor; and
allowing the second user process to access the data in the fourth region of the memory.

8. The method of claim 7, including switching from the first user process to the second user process by storing the second address space identifier in at least one register.

9. The method of claim 1, including:
scheduling a third user process for execution on the at least one physical processor; and
disallowing the third user process from accessing the data in the fourth region of the memory based on the third user process not being associated with the third domain.

10. The method of claim 9, including associating a third address space identifier with the third user process of the first virtual machine and a third region of the memory.

11. The method of claim 1, including:
scheduling a third user process for execution on the at least one physical processor;
disassociating the fourth region of the memory with the third domain; and
disallowing the third user process from accessing the data in the fourth region of the memory based on the fourth region of the memory not being associated with the third domain.

12. The method of claim 1, including:
scheduling a third user process associated with a second different virtual machine for execution on the at least one physical processor; and
disallowing the third user process from accessing the data in the fourth region of the memory based on the third user process being associated with the second virtual machine.

13. The method of claim 1, wherein the fourth region of the memory includes a plurality of noncontiguous segments of the memory.

14. An apparatus for sharing memory between multiple processes of a first virtual machine, the apparatus comprising:
a hypervisor; and
at least one physical processor operatively coupled to the hypervisor;
wherein the hypervisor is structured to:
associate a first region of a memory with a first domain indicative of a user region of the first virtual machine;
associate a second different region of the memory with the first domain indicative of the user region of the first virtual machine;
associate a first address space identifier with a first user process of the first virtual machine and the first region of the memory;
associate a second different address space identifier with a second different user process of the first virtual machine and the second region of the memory, wherein the first address space identifier protects the first region of the memory from access by the second user process, and the second address space identifier protects the second region of the memory from access by the first user process;
associate a third different region of the memory with a second domain indicative of a kernel region of the first virtual machine, wherein the first user process and the second user process each do not have access to the third region of the memory; and
associate a fourth region of the memory with a third domain indicative of a shared region within the kernel region of the first virtual machine, wherein the first user process and the second user process each have access to the fourth region of the memory.

15. The apparatus of claim 14, further comprising a memory management unit operatively coupled to the hypervisor, wherein the first domain, the second domain, and the third domain are each one of a finite number of physical processor domains managed by the memory management unit.

16. The apparatus of claim 15, wherein the hypervisor is structured to recycle the finite number of physical processor domains.

17. The apparatus of claim 14, wherein the hypervisor is structured to switch from the first user process to the second user process by storing the second address space identifier in at least one register.

18. The apparatus of claim 14, wherein the hypervisor is structured to recycle a plurality of address space identifiers.

19. The apparatus of claim 14, wherein the hypervisor is structured to:
store the first address space identifier in at least one register;
schedule the first user process for execution on at least one physical processor; and
allow the first user process to access data in the fourth region of the memory.

20. The apparatus of claim 19, wherein the hypervisor is structured to:
store the second address space identifier in the at least one register;
schedule the second user process for execution on the at least one physical processor; and
allow the second user process to access the data in the fourth region of the memory.

21. The apparatus of claim 20, wherein the hypervisor is structured to switch from the first user process to the second user process by storing the second address space identifier in at least one register.

22. The apparatus of claim 14, wherein the hypervisor is structured to:
schedule a third user process for execution on the at least one physical processor; and
disallow the third user process from accessing the data in the fourth region of the memory based on the third user process not being associated with the third domain.

23. The apparatus of claim 22, wherein the hypervisor is structured to associate a third address space identifier with the third user process of the first virtual machine and a third region of the memory.

24. The apparatus of claim 14, wherein the hypervisor is structured to:
schedule a third user process for execution on the at least one physical processor;
disassociate the fourth region of the memory with the third domain; and
disallow the third user process from accessing the data in the fourth region of the memory based on the fourth region of the memory not being associated with the third domain.

25. The apparatus of claim 14, wherein the hypervisor is structured to:
schedule a third user process associated with a second different virtual machine for execution on the at least one physical processor; and
disallow the third user process from accessing the data in the fourth region of the memory based on the third user process being associated with the second virtual machine.

26. The apparatus of claim 14, wherein the fourth region of the memory includes a plurality of noncontiguous segments of the memory.

27. A computer readable memory storing instructions structured to cause an electronic device to:
associate a first region of a memory with a first domain indicative of a user region of the first virtual machine;
associate a second different region of the memory with the first domain indicative of the user region of the first virtual machine;
associate a first address space identifier with a first user process of the first virtual machine and the first region of the memory;
associate a second different address space identifier with a second different user process of the first virtual machine and the second region of the memory, wherein the first address space identifier protects the first region of the memory from access by the second user process, and the second address space identifier protects the second region of the memory from access by the first user process;
associate a third different region of the memory with a second domain indicative of a kernel region of the first virtual machine, wherein the first user process and the second user process each do not have access to the third region of the memory; and
associate a fourth region of the memory with a third domain indicative of a shared region within the kernel region of the first virtual machine, wherein the first user process and the second user process each have access to the fourth region of the memory.

28. The computer readable memory of claim 27, wherein the instructions are structured to cause the electronic device to communicate with a memory management unit, wherein the first domain, the second domain, and the third domain are each one of a finite number of physical processor domains managed by the memory management unit.

29. The computer readable memory of claim 27, wherein the instructions are structured to cause the electronic device to recycle the finite number of physical processor domains

30. The computer readable memory of claim 27, wherein the instructions are structured to cause the electronic device to switch from the first user process to the second user process by storing the second address space identifier in at least one register.

31. The computer readable memory of claim 27, wherein the instructions are structured to cause the electronic device to recycle a plurality of address space identifiers.

32. The computer readable memory of claim 27, wherein the instructions are structured to cause electronic device to:
store the first address space identifier in at least one register;
schedule the first user process for execution on at least one physical processor; and
allow the first user process to access data in the fourth region of the memory.

33. The computer readable memory of claim 32, wherein the instructions are structured to cause the electronic device to:
store the second address space identifier in the at least one register;
schedule the second user process for execution on the at least one physical processor; and
allow the second user process to access the data in the fourth region of the memory.

34. The computer readable memory of claim 33, wherein the instructions are structured to cause the electronic device to switch from the first user process to the second user process by storing the second address space identifier in at least one register.

35. The computer readable memory of claim 27, wherein the instructions are structured to cause the electronic device to:
schedule a third user process for execution on the at least one physical processor; and
disallow the third user process from accessing the data in the fourth region of the memory based on the third user process not being associated with the third domain.

36. The computer readable memory of claim 35, wherein the instructions are structured to cause the electronic device to associate a third address space identifier with the third user process of the first virtual machine and a third region of the memory.

37. The computer readable memory of claim 27, wherein the instructions are structured to cause the electronic device to:
schedule a third user process for execution on the at least one physical processor;
disassociate the fourth region of the memory with the third domain; and
disallow the third user process from accessing the data in the fourth region of the memory based on the fourth region of the memory not being associated with the third domain.

38. The computer readable memory of claim 27, wherein the instructions are structured to cause the electronic device to:
schedule a third user process associated with a second different virtual machine for execution on the at least one physical processor; and
disallow the third user process from accessing the data in the fourth region of the memory based on the third user process being associated with the second virtual machine.

39. The computer readable memory of claim 27, wherein the fourth region of the memory includes a plurality of noncontiguous segments of the memory.
